(19) United States
(12) Patent Application Publication
(10) Pub. No.: US 2026/0227777 A1
(43) Pub. Date: Aug. 6, 2026

(54) REMOTE OPERATION ASSISTANCE METHOD, REMOTE OPERATION ASSISTANCE APPARATUS, AND COMPUTER PROGRAM PRODUCT

(71) Applicant: Panasonic Intellectual Property Management Co., Ltd., Osaka (JP)

(72) Inventors: Toshihiko KUSAKABE, Osaka Fu (JP); Shunsuke KUHARA, Osaka Fu (JP); Yusuke KUSHIKI, Osaka Fu (JP); Sicong HUANG, Saitama Ken (JP); Takumi KOJIMA, Osaka Fu (JP)

(73) Assignee: Panasonic Intellectual Property Management Co., Ltd., Osaka (JP)

(21) Appl. No.: 19/636,181

(22) Filed: Apr. 1, 2026

Related U.S. Application Data
(63) Continuation of application No. PCT/JP2024/027955, filed on Aug. 5, 2024.

(30) Foreign Application Priority Data
Oct. 12, 2023 (JP) 2023-176821

(51) Int. Cl. G05D 1/227; G05D 1/65; B60W 30/14; B60W 60/00

(52) U.S. Cl. CPC G05D 1/227; G05D 1/65; B60W 30/146; B60W 60/001; B60W 2420/403; B60W 2552/15; B60W 2554/4042; B60W 2554/804; B60W 2556/45; B60W 2720/10

(57) ABSTRACT

A remote operation assistance method according to the present disclosure is executed by a remote operation assistance apparatus configured to assist with remote operation of a vehicle. The method includes: acquiring relationship information indicating a relationship between a speed of the vehicle and a motion vector of a surrounding area of the vehicle captured by a camera mounted on the vehicle; and performing control to assist with the remote operation of the vehicle based on the relationship information acquired at the acquiring.

### CROSS-REFERENCE TO RELATED APPLICATIONS

This application is a continuation of International Application No. PCT/JP2024/027955, filed on August 5, 2024 which claims the benefit of priority of the prior Japanese Patent Application No. 2023-176821, filed on October 12, 2023, the entire contents of which are incorporated herein by reference.

### FIELD

The present disclosure relates to a remote operation assistance method, a remote operation assistance apparatus, and a computer program product.

### BACKGROUND

In recent years, services utilizing various types of autonomous vehicles have been put into practical use, and development of remote control systems capable of remotely monitoring or operating such vehicles from a remote location has been progressing. In such remote control systems, when a request for assistance through remote operation is issued from an autonomous vehicle, an operator in a remote control center is able to provide assistance, such as moving the autonomous vehicle, by remotely operating the autonomous vehicle while viewing images captured by a camera mounted on the autonomous vehicle.

In one example, a technology is known which provides the operator with a sense of speed corresponding to the vehicle's speed by varying the appearance of an image representing a surrounding area of the vehicle in response to the speed of the vehicle.

A related technique is described in JP 2014-71776 A.

However, in a related technique, for example, when remotely operating different types of vehicles, the difference in the viewing angle, the attachment position, or the like of a camera mounted on each vehicle causes the range of the surrounding area captured by the camera to differ, resulting in a change in the sense of speed. This can potentially affect the remote operation by the operator.

### SUMMARY

A remote operation assistance method according to the present disclosure is executed by a remote operation assistance apparatus configured to assist with remote operation of a vehicle. The method includes: acquiring relationship information indicating a relationship between a speed of the vehicle and a motion vector of a surrounding area of the vehicle captured by a camera mounted on the vehicle; and performing control to assist with the remote operation of the vehicle based on the relationship information acquired at the acquiring.

### BRIEF DESCRIPTION OF THE DRAWINGS

FIG. 1 is a diagram illustrating an example of a schematic configuration of a remote operation system according to an embodiment;

FIG. 2 is a diagram illustrating an example of the configuration of each of multiple apparatuses included in a remote operation system according to an embodiment;

FIG. 3 is a diagram illustrating an example of the hardware configuration of a control device according to an embodiment;

FIG. 4 is a diagram illustrating an example of an image captured by a camera mounted on a vehicle according to an embodiment;

FIG. 5 is a diagram illustrating an example of the correspondence between the speed of a vehicle and the magnitude of a motion vector in a surrounding area according to an embodiment;

FIG. 6 is a diagram illustrating an example of slope information associated with each vehicle ID according to an embodiment;

FIG. 7 is a diagram illustrating an example of a surrounding area in an image captured by a wide-angle mode camera according to an embodiment;

FIG. 8 is a diagram illustrating an example of a surrounding area in an image captured by a telephoto mode camera according to an embodiment;

FIG. 9 is a diagram illustrating an example of a surrounding area in an image captured by a camera at a depression angle according to an embodiment;

FIG. 10 is a diagram illustrating an example of a surrounding area in an image captured by a camera at an elevation angle according to an embodiment;

FIG. 11 is a diagram illustrating an example of a correspondence, for each of two vehicles, between the speed of the vehicle and the magnitude of a motion vector in a surrounding area according to an embodiment;

FIG. 12 is a diagram illustrating an example of a warning screen according to an embodiment;

FIG. 13 is a sequence diagram illustrating an example of the operational procedure of a remote operation system when a vehicle that is a target of remote operation is switched, according to an embodiment;

FIG. 14 is a flowchart illustrating an example of the operation of a vehicle in calculating slope information according to an embodiment;

FIG. 15 is a flowchart illustrating an example of the operation of a remote operation assistance apparatus upon reception of a request for assistance according to an embodiment;

FIG. 16 is a diagram illustrating an example of slope information associated with each combination of a vehicle ID and a camera viewing angle according to a modification;

FIG. 17 is a diagram illustrating an example of slope information associated with each combination of a vehicle ID and a location according to a modification;

FIG. 18 is a diagram illustrating an example of a motion vector of a surrounding area associated with each vehicle ID according to a modification; and

FIG. 19 is a diagram illustrating an example of a correspondence, for each of two vehicles, between the magnitude of a motion vector of a surrounding area and the speed of the vehicle, according to a modification.

### DETAILED DESCRIPTION

Hereinafter, a remote operation assistance method, a remote operation assistance apparatus, and a program according to embodiments disclosed herein will be described in detail with reference to the accompanying drawings.

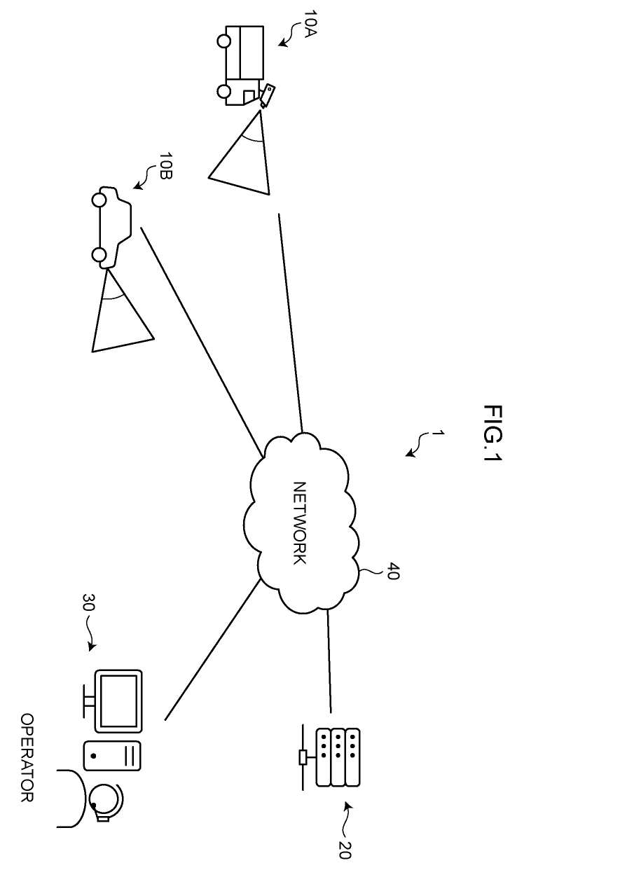

FIG. 1 is a diagram illustrating an example of a schematic configuration of a remote operation system 1 according to the present embodiment. As illustrated in FIG. 1, the remote operation system 1 includes a plurality of vehicles 10A and 10B (two vehicles in the example of FIG. 1), a remote operation assistance apparatus 20, and a terminal apparatus 30. While two vehicles 10A and 10B are illustrated in FIG. 1, the number of vehicles 10 included in the remote operation system 1 is not limited to the illustrated example, and can be changed as appropriate depending on design conditions or the like. In the following description, when distinction between the vehicles 10A and 10B is unnecessary, they may be simply referred to as "vehicle 10". For constituent components of the vehicle 10, identical reference numerals denote identical components.

In the example of FIG. 1, the vehicle 10, the remote operation assistance apparatus 20, and the terminal apparatus 30 are mutually connectable via a network 40, such as the Internet.

The vehicle 10 is a vehicle capable of autonomous travel and is used to provide various services. The remote operation assistance apparatus 20 is an apparatus that assists with remote operation of the vehicle 10. The terminal apparatus 30 is an apparatus operated by an operator who is present in a remote control center. In the remote operation system 1 of the present embodiment, in the case where the vehicle 10 falls into a state in which autonomous travel is unfeasible (e.g., when an obstacle is detected on the travel route), the vehicle 10 transmits an assistance request requesting assistance through the remote operation to the remote operation assistance apparatus 20. The remote operation assistance apparatus 20, upon receiving the assistance request from the vehicle 10, transmits a remote operation request, which requests the remote operation by the operator, to the terminal apparatus 30. The operator of the terminal apparatus 30, upon receiving the remote operation request, can perform the remote operation of the vehicle 10 by operating the terminal apparatus 30 while viewing an image captured by a camera mounted on the vehicle 10, thereby providing assistance such as moving the vehicle 10.

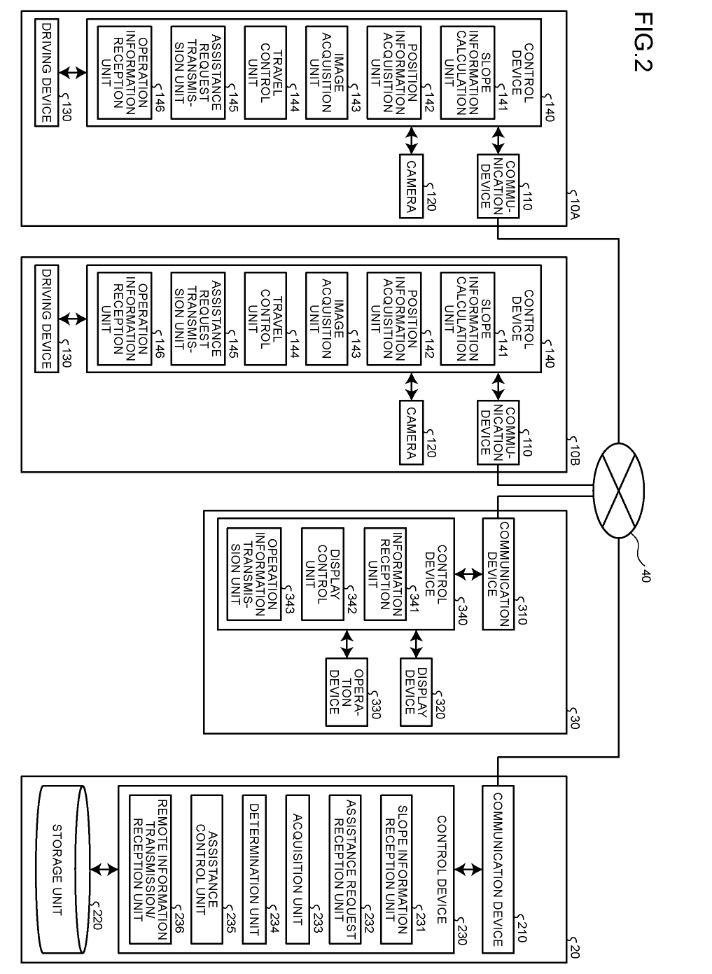

FIG. 2 is a diagram illustrating an example of the configuration of the vehicle 10, the remote operation assistance apparatus 20, and the terminal apparatus 30, which are included in the remote operation system 1. Hereinafter, with reference to FIG. 2, the configuration of each of the vehicle 10, the remote operation assistance apparatus 20, and the terminal apparatus 30 will be described.

The configuration of the vehicle 10 is now described. The following description uses the configuration of one vehicle 10 as an example, but the configurations of other vehicles 10 (other vehicles 10 included in the remote operation system 1) are similar. As illustrated in FIG. 2, the vehicle 10 includes, as hardware components, a communication device 110, a camera 120, a driving device 130, and a control device 140. Moreover, the hardware components of the vehicle 10 are not limited to the configuration illustrated in FIG. 2, and the vehicle 10 may include other hardware components.

The communication device 110 is a device that communicates with an external device (e.g., such as the remote operation assistance apparatus 20) via the network 40. The camera 120 is mounted on the vehicle 10 and is disposed so as to capture an image of the front of the vehicle 10.

The driving device 130 is a device that drives the vehicle 10. The driving device 130 includes, for example, a wheel driving device that applies rotational driving force to wheels, a steering driving device that steers the wheels, and the like.

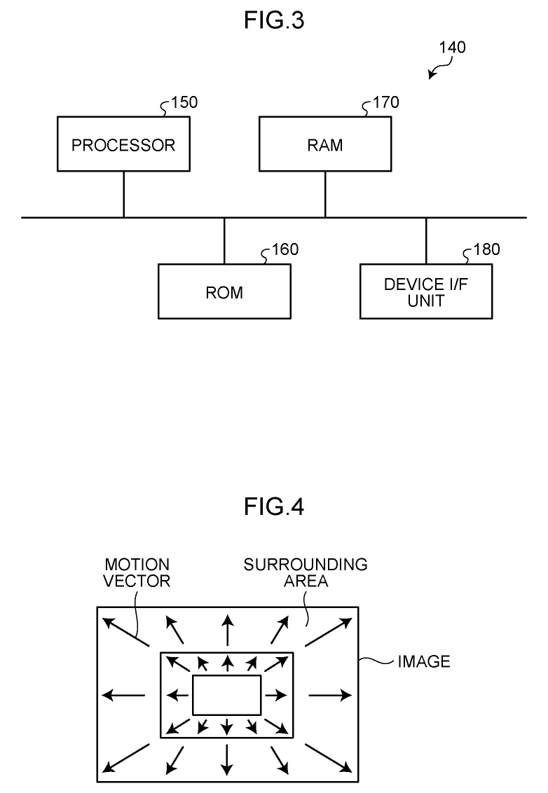

The control device 140 is a device that integrally controls the operation of the vehicle 10. FIG. 3 is a diagram illustrating an example of the hardware configuration of the control device 140. In the present embodiment, the control device 140 is constituted by a computer device. Moreover, the hardware configuration of a control device 230 included in the remote operation assistance apparatus 20 and a control device 340 included in the terminal apparatus 30, which will be described later, is also similar to that illustrated in FIG. 3.

As illustrated in FIG. 3, the control device 140 includes a processor 150, a read-only memory (ROM) 160, a random-access memory (RAM) 170, and a device interface (I/F) unit 180.

The processor 150 is, for example, a central processing unit (CPU). The processor 150 executes a program to integrally control the operations of the control device 140 to implement various functions of the control device 140. The various functions of the control device 140 will be described later.

The ROM 160 is non-volatile memory that stores various types of information, including programs or the like executed by the processor 150. The RAM 170 is volatile memory that provides a working area for the processor 150. The device I/F unit 180 is an interface for connecting to other devices (such as the communication device 110, the camera 120, and the driving device 130).

Referring back to FIG. 2, the functions of the control device 140 will be described. As illustrated in FIG. 2, the control device 140 includes a slope information calculation unit 141, a position information acquisition unit 142, an image acquisition unit 143, a travel control unit 144, an assistance request transmission unit 145, and an operation information reception unit 146. Moreover, in the example of FIG. 2, only the functions necessary to describe the main parts of the present embodiment are illustrated. However, the functions of the control device 140 are not limited to the illustrated ones. In the present embodiment, the processor 150 executes a program stored in the ROM 160 to implement the functions of the respective units or components described above. However, the embodiments disclosed herein are not limited thereto, and a configuration in which some or all of these functions are implemented by a dedicated hardware circuit (such as a semiconductor integrated circuit) may be adopted.

The slope information calculation unit 141 calculates slope information that indicates a slope, which is a ratio between a change in a speed of the vehicle 10 and a change in a motion vector of a surrounding area of the vehicle 10. In the present embodiment, the slope information indicates a slope, which is the ratio of a change in the motion vector to a change in the speed of the vehicle 10. The slope information is one example of "relationship information" that indicates a relationship between the speed of the vehicle 10 and the motion vector of the surrounding area of the vehicle 10 captured by the camera 120 mounted on the vehicle 10.

In the present embodiment, before the service operation, the vehicle 10 is caused to travel along a predetermined route, and the slope information calculation unit 141, based on the speed of the vehicle 10 and the image captured by the camera 120, calculates a slope corresponding to a linear equation indicating a correspondence between the speed of the vehicle 10 and the motion vector of the surrounding area of the vehicle 10, and transmits slope information indicating the calculated slope to the remote operation assistance apparatus 20. Moreover, the timing for calculating the slope information is not limited to timing before the service operation and can be set in any manner. For example, the slope information calculation unit 141 may calculate and update the slope information during the service operation.

An example of how to determine a surrounding area of the vehicle 10 and a motion vector of the surrounding area of the vehicle 10 is described below. During travel of the vehicle 10, the camera 120, which captures an image of the front of the vehicle 10, captures an image (moving image) in which a road surface and the like flow in a direction opposite to the traveling direction of the vehicle 10, as illustrated in FIG. 4. In this image, even at the same speed, a region closer to the edge (periphery) appears to move faster because the apparent amount of movement is larger. In other words, as the vehicle 10 travels, a subject flows faster in a region closer to an edge of the image, and the flow of the subject becomes slower as the subject is closer to an inner side of the image from the edge.

Thus, for example, the slope information calculation unit 141 is capable of determining a motion vector by searching for a similar block between frames for each block (block matching method), with each block being a unit used to divide an image captured by the camera 120, and is capable of setting as the surrounding area any block in which the motion vector magnitude is greater than or equal to a reference. This allows both the setting of the surrounding area and the calculation of motion vectors included in the surrounding area to be performed simultaneously. Moreover, the method of calculating the motion vector is not limited to the block matching method described above; for example, a motion vector can be calculated for each pixel of an image by using a gradient method, and pixels having a motion vector greater than or equal to a reference value can be set as the surrounding area. Furthermore, a motion vector output from a codec used for video transmission can be used to calculate a motion vector of the surrounding area. Alternatively, for example, for each of the cameras 120, a predetermined peripheral region of an image captured by the camera 120 may be preset as the surrounding area.

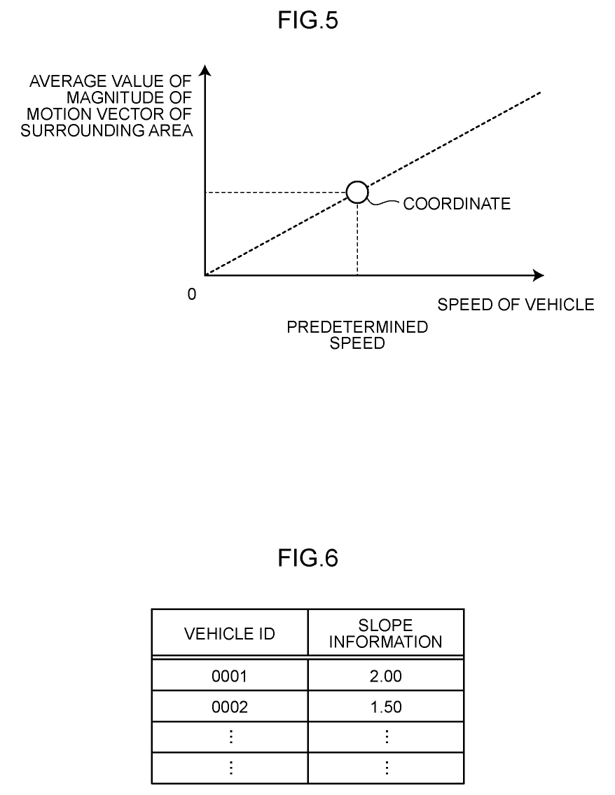

An example method of calculating the slope information is now described. In the present embodiment, as illustrated in FIG. 5, a coordinate system is established in which the horizontal axis represents the speed of the vehicle 10 and the vertical axis represents the average value of the magnitudes of the motion vectors of the respective blocks included in the surrounding area. The slope information calculation unit 141 calculates coordinates indicating a corresponding point between the average value of the magnitudes of the motion vectors of the surrounding area, which is calculated as described above, and the speed of the vehicle 10 at the moment that the average value is obtained (denoted as "predetermined speed" in FIG. 5). Then, the slope information calculation unit 141 is capable of calculating a linear equation that connects the calculated coordinates and the origin of the coordinate system (an example of a function indicating the correspondence between the speed of the vehicle 10 and the motion vector of the surrounding area), and calculating a slope of the calculated linear equation. The information indicating the slope calculated as described above becomes the slope information.

Moreover, in the example of FIG. 5, the vertical axis represents the average value of the magnitudes of the motion vectors of the respective blocks included in the surrounding area, but it is not limited to this; for example, a cumulative value of the magnitudes of the motion vectors of the respective blocks included in the surrounding area may instead be used as the vertical axis. Even in this case, the slope information calculation unit 141 is capable of calculating the slope information using a method similar to that described above.

The slope information calculation unit 141 transmits the slope information calculated as described above and a vehicle ID indicating information used to identify the vehicle 10 to the remote operation assistance apparatus 20, and the remote operation assistance apparatus 20 stores the slope information and the vehicle ID received from the vehicle 10 in association with each other. The detailed configuration of the remote operation assistance apparatus 20 will be described later. Moreover, in the present embodiment, the slope information calculation unit 141 performs both the function of calculating the slope information and the function of transmitting the slope information; however, the present disclosure is not limited thereto, and for example, a configuration in which the function of calculating the slope information and the function of transmitting the slope information are separately provided may also be adopted.

Referring back to FIG. 2, the description of functions of the control device 140 of the vehicle 10 is continued. The position information acquisition unit 142 acquires position information that indicates a position of the vehicle 10. Various known technologies can be used as a method of acquiring the position information, but for example, the position information acquisition unit 142 is capable of receiving a GPS signal indicating radio waves transmitted from each of multiple GPS satellites, is capable of calculating the position of the vehicle 10 using three-dimensional positioning based on the received GPS signal, and is capable of acquiring position information indicating the obtained position.

The image acquisition unit 143 acquires an image captured by the camera 120. The image acquired by the image acquisition unit 143 is also used to calculate the above-described slope information. Furthermore, during travel of the vehicle 10 after the start of service operation, the image acquired by the image acquisition unit 143 is transmitted to the remote operation assistance apparatus 20.

In an autonomous travel mode indicating a state in which the vehicle 10 autonomously travels, the travel control unit 144 performs control (control to drive the driving device 130), based on a target position and the position information acquired by the position information acquisition unit 142, to cause the vehicle 10 to travel toward the target position. On the other hand, in a remote operation mode indicating a state in which the vehicle 10 is remotely operated by an operator, the travel control unit 144 performs control to cause the vehicle 10 to travel based on operation information indicating information input to the terminal apparatus 30 in response to operation by the operator. In the present embodiment, the travel modes of the vehicle 10 include the autonomous travel mode described above and the remote operation mode described above, and the vehicle 10 basically travels in the autonomous travel mode and travels in the remote operation mode when the vehicle 10 falls into a state in which autonomous travel is unfeasible.

The assistance request transmission unit 145, for example, in the case where the vehicle 10 is in a state in which autonomous travel is not feasible during the autonomous travel mode, transmits an assistance request to the remote operation assistance apparatus 20, the assistance request requesting assistance through remote operation. An example of a state in which the vehicle 10 is incapable of autonomous travel is a state in which, for example, an object of a predetermined size (a size for which the vehicle 10 is determined to be unable to move straight ahead) or larger exists in the traveling direction of the vehicle 10. In the present embodiment, the assistance request transmission unit 145 detects that an object of a predetermined size or larger exists in the traveling direction of the vehicle 10 based on the image acquired by the image acquisition unit 143, and in such a case, transmits an assistance request to the remote operation assistance apparatus 20. In the present embodiment, the assistance request is information that includes at least information requesting assistance through remote operation and a vehicle ID that indicates information for identifying the vehicle 10.

The operation information reception unit 146 receives operation information transmitted from the terminal apparatus 30 via the remote operation assistance apparatus 20. After the assistance request transmission unit 145 transmits the assistance request, the travel control unit 144 performs control to cause the vehicle 10 to travel based on the operation information received by the operation information reception unit 146, and does not perform travel control based on the target position and the position information. In other words, the travel mode of the vehicle 10 switches from the autonomous travel mode to the remote operation mode.

The configuration of the remote operation assistance apparatus 20 is now described. As illustrated in FIG. 2, the remote operation assistance apparatus 20 includes, as hardware components, a communication device 210, a storage unit 220, and a control device 230. Moreover, the hardware components of the remote operation assistance apparatus 20 are not limited to the configuration illustrated in FIG. 2, and the remote operation assistance apparatus 20 may include other hardware components.

The communication device 210 is a device that communicates with an external device (e.g., such as the vehicle 10 and the terminal apparatus 30) via the network 40.

The storage unit 220 stores the slope information in association with each vehicle 10. In the present embodiment, as illustrated in FIG. 6, the storage unit 220 stores the slope information in association with each vehicle ID indicating information that identifies the vehicle. Moreover, the storage format of the slope information is not limited to the example illustrated in FIG. 6.

The control device 230 is a device that integrally controls the operation of the remote operation assistance apparatus 20. In the present embodiment, the control device 230 is constituted by a computer device and has a hardware configuration similar to that illustrated in FIG. 3.

The description of the functions of the control device 230 of the remote operation assistance apparatus 20 is continued. As illustrated in FIG. 2, the control device 230 includes a slope information reception unit 231, an assistance request reception unit 232, an acquisition unit 233, a determination unit 234, an assistance control unit 235, and a remote information transmission/reception unit 236. Moreover, in the example of FIG. 2, only the functions necessary to describe the main parts of the present embodiment are illustrated, and the functions of the control device 230 are not limited thereto. In the present embodiment, the processor 150 executes a program stored in the ROM 160 to implement the functions of the respective units or components described above. However, the present disclosure is not limited thereto, and a configuration in which some or all of these functions are implemented by a dedicated hardware circuit may also be adopted.

The slope information reception unit 231 receives the slope information and vehicle ID transmitted from the vehicle 10 as described above. Then, the slope information reception unit 231 stores, in the storage unit 220, the slope information and the vehicle ID received from the vehicle 10 in association with each other (see FIG. 6). Moreover, in the present embodiment, the slope information reception unit 231 has both the function of receiving the slope information and the function of storing the slope information in the storage unit 220; however, the present disclosure is not limited thereto, and for example, a configuration in which the function of receiving the slope information and the function of storing the slope information in the storage unit 220 are separately provided may also be adopted.

The assistance request reception unit 232 receives the assistance request transmitted from the vehicle 10 as described above.

The acquisition unit 233 acquires the above-described slope information. More specifically, upon reception of an assistance request by the assistance request reception unit 232, the acquisition unit 233 according to the present embodiment identifies the vehicle ID included in the received assistance request. Then, the acquisition unit 233 acquires the slope information associated with the identified vehicle ID from the storage unit 220. In the present embodiment, the acquisition unit 233 acquires slope information each time an assistance request is received by the assistance request reception unit 232. As described above, an assistance request is transmitted for each vehicle 10, and receiving an assistance request from another vehicle 10 after receiving an assistance request from one vehicle 10 can be considered as a case in which the vehicle 10 to be remotely operated switches from one vehicle to another.

The determination unit 234 determines whether the slope indicated by the slope information acquired by the acquisition unit 233 decreases. More specifically, after the acquisition unit 233 acquires first slope information indicating the slope corresponding to a first vehicle 10 and subsequently acquires second slope information indicating the slope corresponding to a second vehicle 10, the determination unit 234 determines whether the slope indicated by the second slope information is smaller than the slope indicated by the first slope information.

In this context, since the "second vehicle 10" can be regarded as corresponding to the vehicle 10 that has transmitted the most recent assistance request and the "first vehicle 10" can be regarded as corresponding to the vehicle 10 that transmitted an assistance request immediately prior to the most recent assistance request, the "second slope information" corresponds to the slope information most recently acquired by the acquisition unit 233, and the "first slope information" corresponds to the slope information acquired by the acquisition unit 233 immediately before the second slope information. In the present embodiment, each time slope information is acquired by the acquisition unit 233, the determination unit 234 compares the slope indicated by the most recently acquired slope information (second slope information) with the slope indicated by the slope information acquired immediately before the most recently acquired slope information (first slope information), and determines whether the slope indicated by the slope information decreases.

The assistance control unit 235 performs control to assist with the remote operation of the vehicle 10 based on the slope information acquired by the acquisition unit 233. More specifically, the assistance control unit 235 performs control to assist with the remote operation of the vehicle 10 in response to a change in the slope indicated by the slope information acquired by the acquisition unit 233. In the present embodiment, the assistance control unit 235 performs control to assist with the remote operation of the vehicle 10 when the slope indicated by the slope information acquired by the acquisition unit 233 decreases. Furthermore, the assistance control unit 235 performs control to assist with the remote operation of the vehicle 10 when the determination unit 234 determines that the slope indicated by the second slope information described above is smaller than the slope indicated by the first slope information described above.

In this context, the sense of speed changes corresponding to a changes in the surrounding area of the vehicle 10 is described. For example, consider a case in which the vehicle 10 to be remotely operated (i.e., the vehicle 10 that transmitted the assistance request) switches from a vehicle 10 equipped with the camera 120 operating in a wide-angle mode having a large viewing angle to a vehicle 10 equipped with the camera 120 operating in a telephoto mode having a small viewing angle. In this example, the camera 120 mounted on the vehicle 10 is capable of switching between the wide-angle mode and the telephoto mode depending on the intended use.

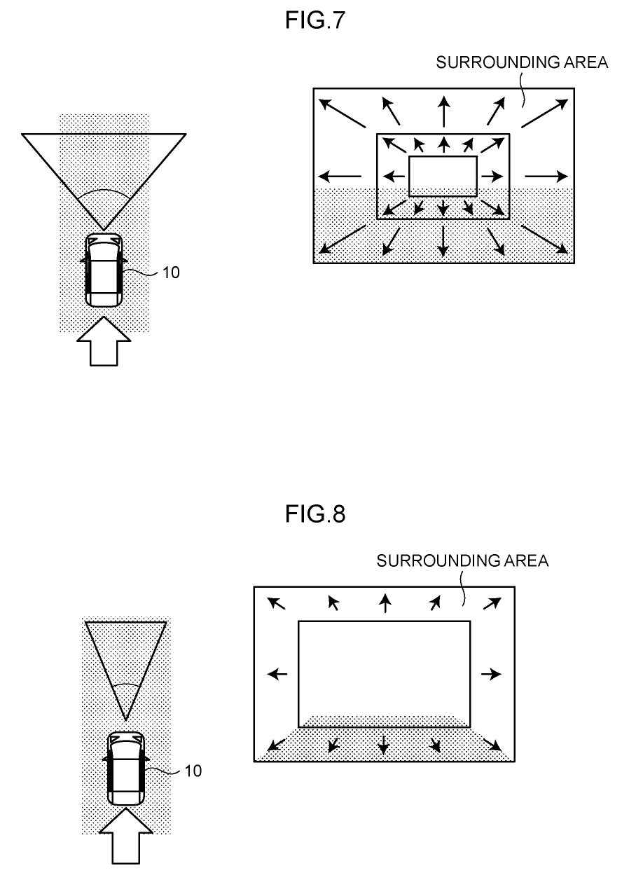

FIG. 7 is a diagram illustrating the vehicle 10 equipped with the wide-angle mode camera 120 and the surrounding area in an image captured by the camera 120. FIG. 8 is a diagram illustrating the vehicle 10 equipped with the telephoto mode camera 120 and the surrounding area in an image captured by the camera 120. As can also be seen from FIGS. 7 and 8, the surrounding area is smaller in the image captured by the camera 120 operating in the telephoto mode than in the wide-angle mode. The surrounding area being smaller causes the average magnitude of the motion vector in the surrounding area to become smaller, leading the operator to feel that the speed of the vehicle 10 is slower (i.e., the sense of speed decreases). Thus, when switching from the state of FIG. 7 to the state of FIG. 8, the sense of speed of the operator makes the speed of the vehicle 10 feel like it slows down, even if the speed of the vehicle 10 remains unchanged. Accordingly, there is a possibility that the operator may excessively increase the speed of the vehicle 10.

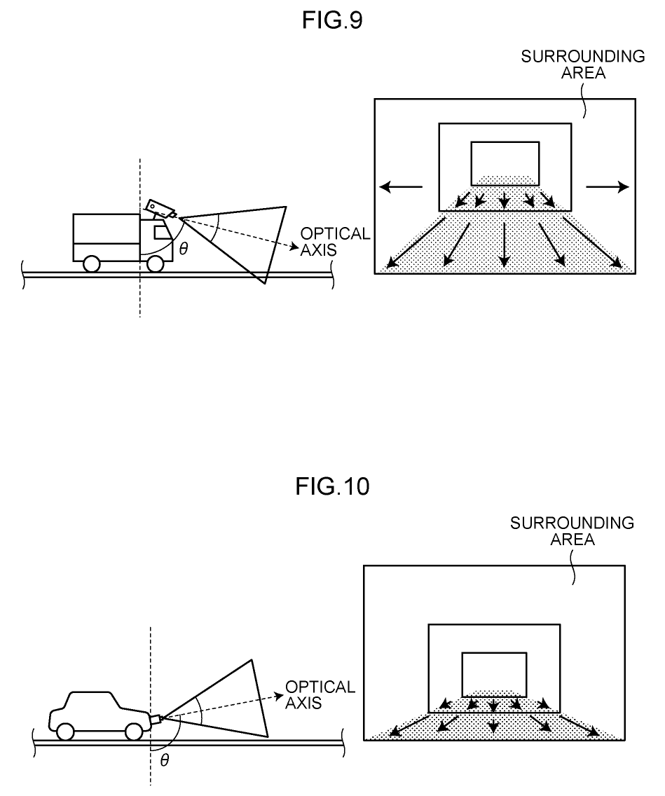

Further, even if the size of the surrounding area does not change significantly, the operator's sense of speed may vary depending on a difference in the range of the surrounding area that includes a region in which the motion vector is large (e.g., such as road surface). FIG. 9 is a diagram illustrating the vehicle 10 equipped with the camera 120 in which the angle θ between a vertical line extending vertically and the optical axis of the camera 120 is less than a reference value (corresponding to a depression angle), and the surrounding area in an image captured by the camera 120. FIG. 10 is a diagram illustrating the vehicle 10 equipped with the camera 120 in which the angle θ between a vertical line and the optical axis of the camera 120 is greater than or equal to a reference value (corresponding to an elevation angle), and the surrounding area in an image captured by the camera 120. As can also be seen from FIGS. 9 and 10, the image captured by the camera 120 with an elevation angle imaging range has a smaller range of the surrounding area that includes a road surface region having a large motion vector, and as a result, the average value of the magnitudes of the motion vectors in the surrounding area is also smaller. Thus, switching from the state illustrated in FIG. 9 to the state illustrated in FIG. 10 causes the operator to feel that the speed of the vehicle 10 is slower, even if the actual speed of the vehicle 10 remains unchanged. As a result, similar to the above, there is a possibility that the operator may excessively increase the speed of the vehicle 10.

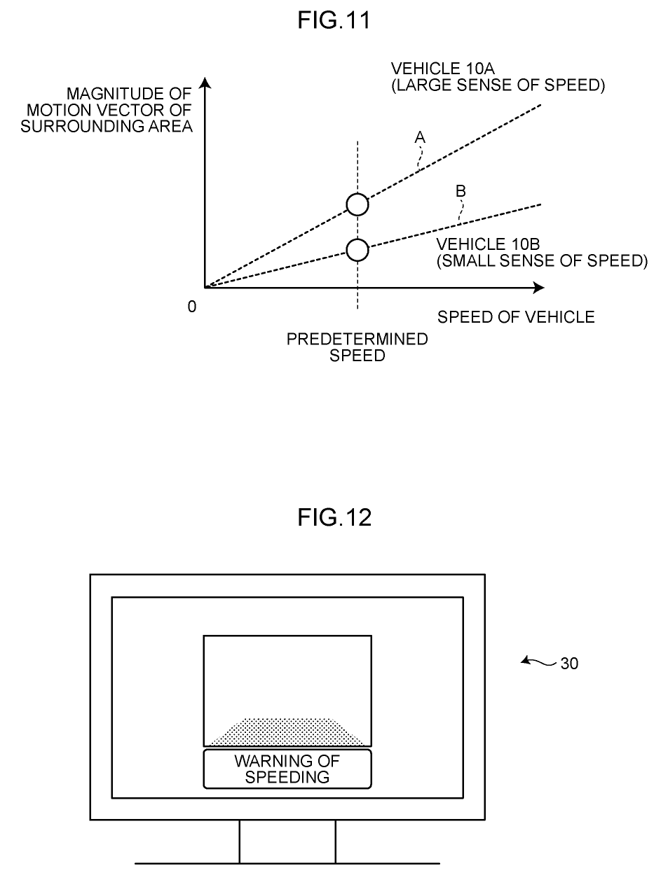

A decrease in the average value of the magnitudes of the motion vectors of the surrounding area causes the slope indicated by the above-described slope information to become smaller, and in such a case, the operator's sense of speed is expected to decrease. Thus, in the present embodiment, the remote operation assistance apparatus 20 determines whether the slope indicated by the above-described slope information decreases and, if the slope indicated by the above-described slope information is determined to be decreasing, the remote operation assistance apparatus 20 performs control to assist with the remote operation by the operator. For example, if the slope indicated by the slope information acquired by the acquisition unit 233 decreases from the slope of line A corresponding to a vehicle 10A to the slope of line B corresponding to a vehicle 10B illustrated in FIG. 11, the assistance control unit 235 performs, as control to assist with the remote operation of the vehicle 10, control that suppresses excessive increase in the speed of the vehicle 10 by the operator.

In the present embodiment, as control to assist with the remote operation of the vehicle 10, the assistance control unit 235 performs control to notify of a decrease in the slope. As one example of control to notify of the decrease in the slope, control that issues a warning of a potential speeding may be performed. For example, the assistance control unit 235 may control the terminal apparatus 30 to display a warning screen as illustrated in FIG. 12. Moreover, the example of control to notify of a decrease in the slope is not limited thereto; for example, the assistance control unit 235 may perform control to cause the terminal apparatus 30 to audibly output information warning of a potential speeding instead of the warning screen illustrated in FIG. 12 Furthermore, for example, the assistance control unit 235 can refer to the past history and, if the type of the vehicle 10 corresponding to the decreased slope information is the same as the type of the vehicle 10 previously operated, can control the terminal apparatus 30 to output information (as an image output or an audio output) notifying that the sense of speed corresponds to that of the vehicle 10 previously operated by the operator.

In the present embodiment, the assistance control unit 235, when the slope indicated by the slope information acquired by the acquisition unit 233 decreases, transmits, to the terminal apparatus 30, assistance information indicating information for assisting with the remote operation of the vehicle 10 (e.g., information indicating the warning screen described above) and a remote operation request indicating information for requesting the remote operation of the vehicle 10. On the other hand, when the slope indicated by the slope information acquired by the acquisition unit 233 is not decreasing, the assistance control unit 235 transmits the remote operation request to the terminal apparatus 30 without transmitting the assistance information.

Referring back to FIG. 2, the description of the functions of the control device 230 of the remote operation assistance apparatus 20 is continued. The remote information transmission/reception unit 236 performs transmission and reception of remote information indicating information used for the remote operation of the vehicle 10. The remote information includes, for example, operation information transmitted from the terminal apparatus 30, information such as an image captured by the camera 120 of the vehicle 10, and the like. For example, the remote information transmission/reception unit 236 is capable of receiving the operation information transmitted from the terminal apparatus 30 and transmitting the received operation information to the vehicle 10. In addition, as described above, during travel of the vehicle 10 after the start of service operation, the image captured by the camera 120 of the vehicle 10 is transmitted to the remote operation assistance apparatus 20, and the remote information transmission/reception unit 236 is capable of transmitting the image received from the vehicle 10 to the terminal apparatus 30.

The configuration of the terminal apparatus 30 is now described. As illustrated in FIG. 2, the terminal apparatus 30 includes, as hardware components, a communication device 310, a display device 320, an operation device 330, and a control device 340. Moreover, the hardware components of the terminal apparatus 30 are not limited to the configuration illustrated in FIG. 2, and the terminal apparatus 30 may be configured to include other hardware components.

The communication device 310 is a device that communicates with an external device (e.g., such as the remote operation assistance apparatus 20) via the network 40. The display device 320 is a device that displays various types of information and is configured, for example, by a liquid crystal display or the like. The operation device 330 is a device through which an operator performs various operations.

The control device 340 is a device that integrally controls the operation of the terminal apparatus 30. In the present embodiment, the control device 340 is constituted by a computer device and has hardware configuration similar to that illustrated in FIG. 3.

The functions of the control device 340 are now described. As illustrated in FIG. 2, the control device 340 includes an information reception unit 341, a display control unit 342, and an operation information transmission unit 343. Moreover, in the example in FIG. 2, only the functions necessary for the description of the main parts of the present embodiment are illustrated, and the functions of the control device 340 are not limited thereto. In the present embodiment, the processor 150 executes a program stored in the ROM 160 to implement the functions of the respective units or components described above. However, the present disclosure is not limited thereto, and a configuration in which some or all of these functions are implemented by a dedicated hardware circuit may also be adopted.

The information reception unit 341 receives various types of information transmitted from the remote operation assistance apparatus 20. For example, the information reception unit 341 is capable of receiving information, such as the above-described remote operation request, the above-described assistance information, and the image captured by the camera 120 of the vehicle 10, from the remote operation assistance apparatus 20.

The display control unit 342 performs control to cause the display device 320 to display various types of information. For example, the display control unit 342 is capable of performing control to cause the display device 320 to display the above-described remote operation request (e.g., such as a message requesting remote operation), performing control to cause the display device 320 to display the above-described assistance information (e.g., such as a warning screen), and performing control to cause the display device 320 to display the image captured by the camera 120 of the vehicle 10. For example, in the above-described remote operation mode, the image captured by the camera 120 of the vehicle 10 is transmitted to the terminal apparatus 30 via the remote operation assistance apparatus 20, and the display control unit 342 displays the image received from the remote operation assistance apparatus 20 on the display device 320, allowing the operator to perform the remote operation of the vehicle 10 while checking the traveling state of the vehicle 10.

The operation information transmission unit 343 transmits operation information to the remote operation assistance apparatus 20, the operation information being input in response to the operation performed by the operator on the operation device 330. For example, after checking the above-described remote operation request displayed on the display device 320, the operator operates the operation device 330 to start the remote operation of the vehicle 10, and the operation information transmission unit 343 is capable of transmitting, to the remote operation assistance apparatus 20, the operation information input in response to the operation performed by the operator on the operation device 330.

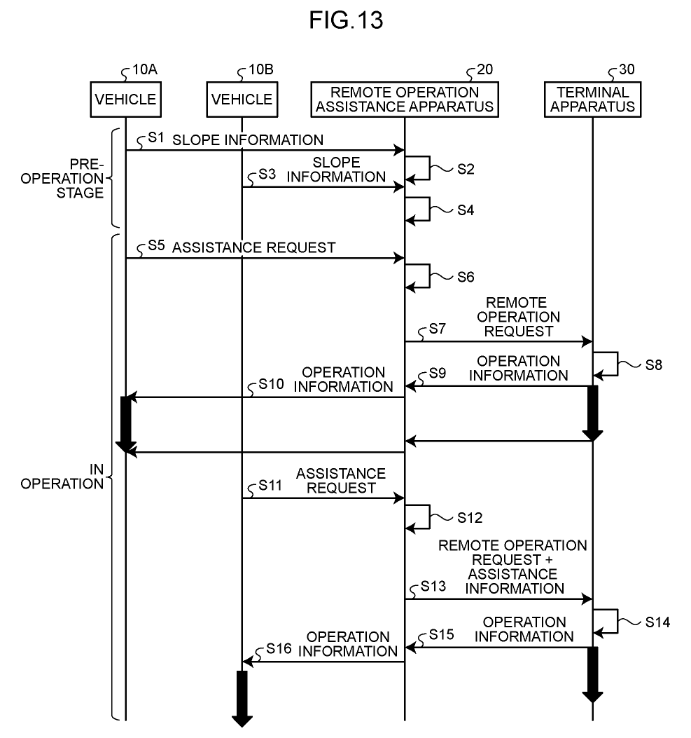

With reference to FIG. 13, a description is given of an example operation procedure of the remote operation system 1 in the case where the target of the remote operation switches from the vehicle 10A to the vehicle 10B.

Initially, before the start of service operation, the vehicle 10A calculates the above-described slope information and transmits the calculated slope information and the vehicle ID to the remote operation assistance apparatus 20 (step S1). The remote operation assistance apparatus 20 stores, in the storage unit 220, the slope information and the vehicle ID received from the vehicle 10A in association with each other (step S2). Similarly, the vehicle 10B transmits the slope information and vehicle ID to the remote operation assistance apparatus 20 (step S3), and the remote operation assistance apparatus 20 stores, in the storage unit 220, the slope information and the vehicle ID received from the vehicle 10B in association with each other (step S4).

The following describes the operation procedure after the start of service operation. In the example of FIG. 13, the vehicle 10A first enters a state in which autonomous travel is unfeasible and transmits the above-described assistance request to the remote operation assistance apparatus 20 (step S5). Upon receiving the assistance request from the vehicle 10A, the remote operation assistance apparatus 20 acquires, from the storage unit 220, the slope information corresponding to the vehicle ID of the vehicle 10A included in the assistance request, and determines whether the slope indicated by the acquired slope information is smaller than the slope indicated by the slope information previously acquired (step S6). In this example, since it is assumed that no assistance request prior to the assistance request from the vehicle 10A is received, the determination result in step S6 is negative. Since the determination result in step S6 is negative, control to assist with the remote operation of the vehicle 10A is unnecessary, and the remote operation assistance apparatus 20 transmits the above-described remote operation request to the terminal apparatus 30 without transmitting the above-described assistance information (step S7).

The terminal apparatus 30 displays the remote operation request received from the remote operation assistance apparatus 20 (step S8). After checking the remote operation request, the operator begins the remote operation of the vehicle 10A, and the terminal apparatus 30 transmits the operation information corresponding to the operation performed by the operator to the remote operation assistance apparatus 20 (step S9). The remote operation assistance apparatus 20 transmits the operation information received from the terminal apparatus 30 to the vehicle 10A (step S10), and the vehicle 10A travels in response to the operation information received from the remote operation assistance apparatus 20. In other words, the vehicle 10A travels in response to the remote operation performed by the operator.

Subsequently, in the example of FIG. 13, the vehicle 10B enters a state in which autonomous travel is not feasible and transmits the above-described assistance request to the remote operation assistance apparatus 20 (step S11). Upon receiving the assistance request from the vehicle 10B, the remote operation assistance apparatus 20 acquires, from the storage unit 220, the slope information corresponding to the vehicle ID of the vehicle 10B included in the assistance request, and determines whether the slope indicated by the acquired slope information is smaller than the slope indicated by the previously acquired slope information corresponding to the vehicle 10A (step S12). In this case, as illustrated in FIG. 11, the slope of the straight line corresponding to the vehicle 10B (the straight line indicating the correspondence between the speed of the vehicle 10 and the magnitude of the motion vector in the surrounding area) is smaller than the slope of the straight line corresponding to the vehicle 10A, so the determination result in step S12 is affirmative. Since the determination result in step S12 is affirmative, control to assist with the remote operation of the vehicle 10B is necessary, and the remote operation assistance apparatus 20 transmits the above-described remote operation request and the above-described assistance information to the terminal apparatus 30 (step S13).

The terminal apparatus 30 displays the remote operation request and the assistance information received from the remote operation assistance apparatus 20 (step S14). After checking the remote operation request and the assistance information, the operator begins the remote operation of the vehicle 10B. In this event, the warning screen (assistance information) such as that illustrated in FIG. 12 is displayed on the display device 320 of the terminal apparatus 30, thereby preventing the operator from excessively increasing the speed of the vehicle 10B due to a decreased sense of speed. The terminal apparatus 30 transmits the operation information corresponding to the operation performed by the operator to the remote operation assistance apparatus 20 (step S15). The remote operation assistance apparatus 20 transmits the operation information received from the terminal apparatus 30 to the vehicle 10B (step S16), and the vehicle 10B travels in response to the operation information received from the remote operation assistance apparatus 20. In other words, the vehicle 10B travels in response to the remote operation performed by the operator.

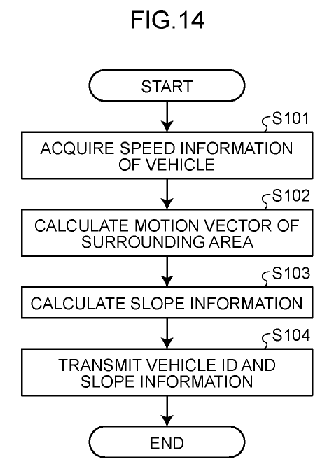

FIG. 14 is a flowchart illustrating an example of the operation of the vehicle 10 in calculating the above-described slope information. As illustrated in FIG. 14, the slope information calculation unit 141 first acquires speed information indicating the speed of the vehicle 10 (step S101). Subsequently, the slope information calculation unit 141 calculates a motion vector of the surrounding area of the vehicle 10 based on an image captured by the camera 120 (step S102). Next, the slope information calculation unit 141 calculates a linear equation indicating the correspondence between the speed of the vehicle 10 and the motion vector of the surrounding area based on the speed information acquired in step S101 and the motion vector calculated in step S102, and calculates slope information indicating the slope of the linear equation (step S103). Subsequently, the slope information calculation unit 141 transmits the slope information calculated in step S103 and the vehicle ID to the remote operation assistance apparatus 20 (step S104). The remote operation assistance apparatus 20 (the slope information reception unit 231) stores, in the storage unit 220, the slope information and the vehicle ID received from the vehicle 10 (the slope information calculation unit 141) in association with each other.

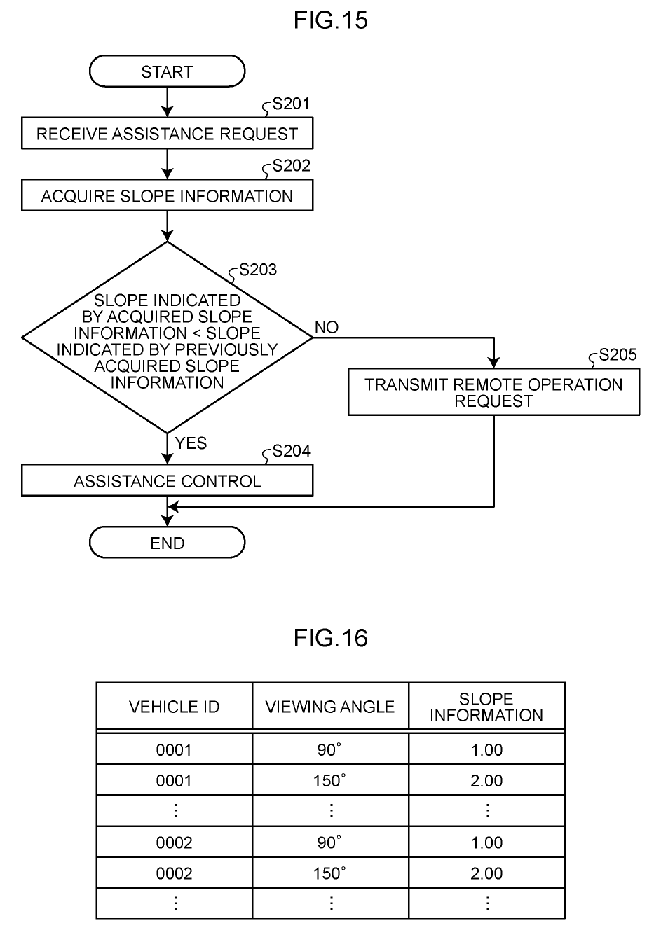

FIG. 15 is a flowchart illustrating an example of the operation of the remote operation assistance apparatus 20 upon receiving the above-described assistance request. As illustrated in FIG. 15, the assistance request reception unit 232 first receives the assistance request from the vehicle 10 (step S201). Subsequently, the acquisition unit 233 acquires, from the storage unit 220, the slope information corresponding to the vehicle ID included in the assistance request received in step S201 (step S202). Next, the determination unit 234 determines whether the slope indicated by the slope information acquired in step S202 (second slope information corresponding to the second vehicle 10 that transmits the most recent assistance request) is smaller than the slope indicated by the previously acquired slope information (first slope information corresponding to the first vehicle 10 that transmits the assistance request immediately before the most recent assistance request) (step S203).

If the result of step S203 is affirmative (step S203: Yes), the assistance control unit 235 performs control to assist with the remote operation of the vehicle 10 (step S204). Although the specific details of this are as described above, the assistance control unit 235 transmits, to the terminal apparatus 30, assistance information indicating information for assisting the remote operation of the vehicle 10 (e.g., information indicating the warning screen described above) and a remote operation request indicating information for requesting the remote operation of the vehicle 10. On the other hand, if the result of step S203 is negative (step S203: No), the assistance control unit 235 transmits only the above-described remote operation request to the terminal apparatus 30 without performing control to assist with the remote operation of the vehicle 10 (step S205).

As described above, in the present embodiment, the remote operation assistance apparatus 20 performs control to assist with the remote operation of the vehicle 10 based on the slope information indicating the slope, which represents the ratio of a change in the motion vector of the surrounding area of the vehicle 10 to a change in the speed of the vehicle 10 (an example of "relationship information"). The control to assist with the remote operation of the vehicle 10 while taking the slope information into consideration makes it possible to appropriately assist the operator with the remote operation. More specifically, in the present embodiment, the remote operation assistance apparatus 20 determines whether the slope indicated by the above-described slope information decreases and, if it is determined that the slope indicated by the slope information decreases, it is expected that the sense of speed of the operator decreases (i.e., the speed of the vehicle 10 feels slower), so the remote operation assistance apparatus 20 performs, as control to assist with the remote operation of the vehicle 10, control that suppresses the operator from excessively increasing the speed of the vehicle 10. As described above, in the present embodiment, the remote operation assistance apparatus 20 performs control to notify of a decrease in the slope as control for restraining the operator from excessively increasing the speed of the vehicle 10. This allows the operator to be restrained from excessively increasing the speed of the vehicle 10. Accordingly, the present embodiment enables to appropriately assist with the remote operation by the operator.

As described above, although the embodiments of the present disclosure have been described, these embodiments have been presented as examples, and are not intended to limit the scope of the invention. These novel embodiments can be implemented in various other forms, and various omissions, substitutions, and changes can be made without departing from the gist of the invention. These novel embodiments and modifications thereof are included in the scope and gist of the invention and are included in the invention described in the claims and the equivalent scope thereof.

Furthermore, the effects in the embodiments described herein are merely illustrative and not limiting, and other effects may also be achieved.

The following describes modifications.

### (1) First Modification

In the above-described embodiment, the storage unit 220 of the remote operation assistance apparatus 20 stores the slope information associated with each vehicle ID; however, the present disclosure is not limited thereto, and, for example, the storage unit 220 can also store the slope information associated with each combination of the vehicle 10 and the viewing angle of the camera 120. Even for the same vehicle 10, the viewing angle may differ depending on the imaging mode of the camera 120, and a configuration may be adopted in which, for example, the viewing angle is set to 90 degrees in a telephoto mode and to 150 degrees in a wide-angle mode. As described above, since the surrounding area becomes larger in the wide-angle mode, the motion vector of the surrounding area also becomes larger, resulting in a greater sense of speed. The slope information may be calculated assuming such situations in advance; for example, as illustrated in FIG. 16, the storage unit 220 may be configured to store the slope information in association with each combination of the above-described vehicle ID for identifying the vehicle 10 and the viewing angle of the camera 120.

In this configuration, the above-described assistance request includes, in addition to the vehicle ID, information indicating the viewing angle of the camera 120. The acquisition unit 233 acquires, from the storage unit 220, the slope information corresponding to the combination of the vehicle ID and the viewing angle of the camera 120 included in the assistance request. The determination unit 234 determines whether the slope indicated by the slope information acquired by the acquisition unit 233 decreases. Similar to the embodiment described above, when the acquisition unit 233 acquires the first slope information corresponding to the combination of the first vehicle 10 and the viewing angle and then acquires second slope information corresponding to the combination of the second vehicle 10 and the viewing angle, the determination unit 234 is capable of determining whether the slope indicated by the second slope information is smaller than the slope indicated by the first slope information.

Moreover, a configuration in which control is performed to assist with the remote operation of the vehicle 10 without using the above-described slope information may also be adopted. For example, in the case where the target of the remote operation switches from the vehicle 10 (first vehicle 10) equipped with the wide-angle mode camera 120 to the vehicle 10 (second vehicle 10) equipped with the telephoto mode camera 120, the assistance control unit 235 is capable of performing control to assist with the remote operation of the vehicle 10 (such as outputting the warning screen described above). In this case, the above-described assistance request may include, in addition to the vehicle ID, camera information capable of identifying the mode of the camera 120 (e.g., information indicating either the wide-angle mode or the telephoto mode, or information indicating the viewing angle). In the case where the acquisition unit 233 acquires camera information included in the assistance request from the first vehicle 10 and then acquires camera information included in the assistance request from the second vehicle 10, the determination unit 234 is capable of determining, based on each piece of the camera information, whether the target of remote operation switches from the vehicle 10 equipped with the wide-angle mode camera 120 to the vehicle 10 equipped with the telephoto mode camera 120. Then, the assistance control unit 235 is capable of performing control to assist with the remote operation of the vehicle 10 based on the determination result of the determination unit 234. As described above, the assistance control unit 235 may perform, as control to assist with the remote operation of the vehicle 10, control that issues a warning of a potential speeding (e.g., control to display the above-described warning screen on the terminal apparatus 30). In this configuration, there is no need to store the slope information for each vehicle ID in the storage unit 220, enabling a reduction in memory capacity.

### (2) Second Modification

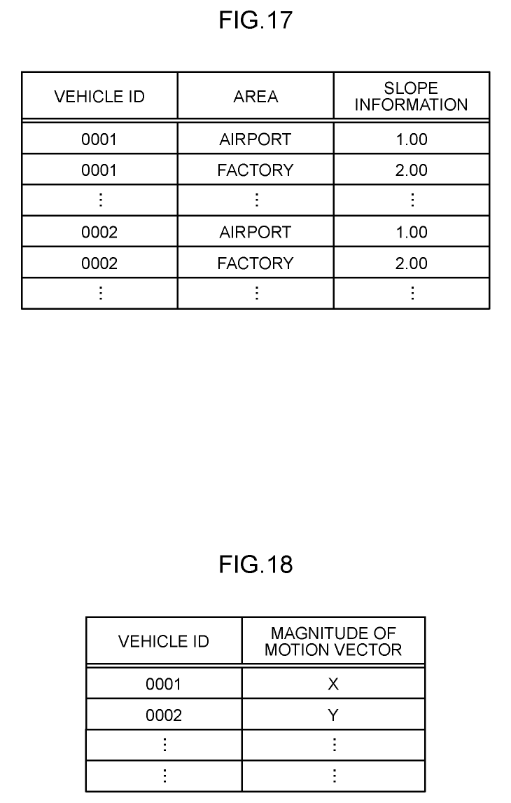

For example, the storage unit 220 may be configured to store the slope information in association with each combination of the vehicle 10 and location (area). For example, in a location where surrounding structures and the like are few, the motion vectors of the surrounding area also tend to become smaller, and thus the sense of speed tends to become smaller. The slope information may be calculated in advance by assuming such a situation; for example, as illustrated in FIG. 17, the storage unit 220 may be configured to store the slope information in association with each combination of the vehicle ID and the location.

In this configuration, the above-described assistance request includes, in addition to the vehicle ID, location information indicating the current location of the vehicle 10. The acquisition unit 233 acquires, from the storage unit 220, the slope information corresponding to the combination of the vehicle ID included in the assistance request and the location indicated by the location information. Similar to the embodiment described above, in the case where the acquisition unit 233 acquires the first slope information corresponding to the combination of the first vehicle 10 and a location and then acquires the second slope information corresponding to the combination of the second vehicle 10 and a location, the determination unit 234 is capable of determining whether the slope indicated by the second slope information is smaller than the slope indicated by the first slope information.

Moreover, a configuration in which control is performed to assist with the remote operation of the vehicle 10 without using the above-described slope information may also be adopted. For example, in the case where the target of remote operation switches from the vehicle 10 (first vehicle 10) located in an area with many surrounding structures or the like to the vehicle 10 (second vehicle 10) in an area with few surrounding structures or the like, the assistance control unit 235 is capable of performing control to assist with the remote operation of the vehicle 10 described above. In the case where the acquisition unit 233 acquires location information included in the assistance request of the first vehicle 10 and then acquires location information included in the assistance request of the second vehicle 10, the determination unit 234 is capable of determining, based on the respective pieces of location information, whether the target of remote operation switches from the vehicle 10 located in the area with many surrounding structures or the like to the vehicle 10 located in the area with few surrounding structures or the like. Then, the assistance control unit 235 is capable of performing control to assist with the remote operation of the vehicle 10 based on the determination result of the determination unit 234. In this configuration, there is no need to store the slope information for each vehicle ID in the storage unit 220, enabling a reduction in memory capacity.

### (3) Third Modification

In one example, instead of the viewing angle of the camera 120 in the above-described first modification, the attachment angle θ of the camera 120 (the angle θ between the above-described vertical line and the optical axis of the camera 120) may be used. As described above, if the attachment angle θ of the camera 120 is a depression angle, the range that includes the road surface region having a large motion in the surrounding area becomes larger, so the motion vector of the surrounding area also becomes larger and the sense of speed also becomes greater. The slope information may be calculated in advance by assuming such a situation, and the storage unit 220 may store the slope information in association with each combination of the vehicle ID and the attachment angle θ of the camera 120.

In this configuration, the above-described assistance request includes, in addition to the vehicle ID, information indicating the attachment angle θ of the camera 120. The vehicle 10 may have a function of detecting the attachment angle θ of the camera 120 in real time using a sensor or the like. Similarly to the above-described embodiment, in the case where the acquisition unit 233 acquires the first slope information corresponding to the combination of the first vehicle 10 and the attachment angle θ of the camera 120 and then acquires the second slope information corresponding to the combination of the second vehicle 10 and the attachment angle θ of the camera 120, the determination unit 234 is capable of determining whether the slope indicated by the second slope information is smaller than the slope indicated by the first slope information.

Moreover, a configuration in which control is performed to assist with the remote operation of the vehicle 10 without using the above-described slope information may also be adopted. For example, in the case where the target of remote operation switches from the vehicle 10 (first vehicle 10) equipped with the camera 120 having the attachment angle θ of a depression angle to the vehicle 10 (second vehicle 10) equipped with the camera 120 having the attachment angle θ of an elevation angle, the assistance control unit 235 is capable of performing control to assist with the remote operation of the vehicle 10. In the case where the acquisition unit 233 acquires information indicating the attachment angle θ of the camera 120 included in the assistance request of the first vehicle 10 and then acquires information indicating the attachment angle θ of the camera 120 included in the assistance request of the second vehicle 10, the determination unit 234 is capable of determining, based on the information indicating the attachment angles θ of each camera 120, whether the target of remote operation switches from the vehicle 10 equipped with the camera 120 having the attachment angle θ of a depression angle to the vehicle 10 equipped with the camera 120 having the attachment angle θ of an elevation angle. Then, the assistance control unit 235 is capable of performing control to assist with the remote operation of the vehicle 10 based on the determination result of the determination unit 234. In this configuration, there is no need to store the slope information for each vehicle ID in the storage unit 220, enabling a reduction in memory capacity.

### (4) Fourth Modification

For example, the storage unit 220 may be configured to store the slope information associated with each combination of the vehicle 10 and an environment (a vehicle external environment such as weather, daytime, or nighttime). In rainy weather or at night, poor visibility reduces the motion vectors in the surrounding area, leading to a tendency for the sense of speed to decrease. The slope information may be calculated in advance by assuming such a situation, and the storage unit 220 may be configured to store the slope information in association with each combination of the vehicle ID and the environment.

In this configuration, the above-described assistance request includes, in addition to the vehicle ID, environmental information indicating the current external environment of the vehicle 10. The acquisition unit 233 acquires, from the storage unit 220, the slope information corresponding to the combination of the vehicle ID included in the assistance request and the environment indicated by the environmental information. Similar to the above-described embodiment, in the case where the acquisition unit 233 acquires the first slope information corresponding to the combination of the first vehicle 10 and the environment and then acquires the second slope information corresponding to the combination of the second vehicle 10 and the environment, the determination unit 234 is capable of determining whether the slope indicated by the second slope information is smaller than the slope indicated by the first slope information.

Moreover, a configuration in which control is performed to assist with the remote operation of the vehicle 10 without using the above-described slope information may also be adopted. For example, in the case where the target of remote operation switches from the vehicle 10 (first vehicle 10) in a clear weather or daytime environment to the vehicle 10 (second vehicle 10) in a rainy weather or nighttime environment (an environment in which the motion vector of the surrounding area becomes smaller than in a clear weather or daytime environment), the assistance control unit 235 is capable of performing control to assist with the remote operation of the vehicle 10 described above. In the case where the acquisition unit 233 acquires environmental information included in the assistance request of the first vehicle 10 and then acquires the environmental information included in the assistance request of the second vehicle 10, the determination unit 234 is capable of determining, based on each piece of environmental information, whether the target of remote operation switches from the vehicle 10 in a clear weather or daytime environment to the vehicle 10 in a rainy weather or nighttime environment. In this context, for example, a situation can also be assumed where there is a time difference between the location of the first vehicle 10 and the location of the second vehicle 10 and the target of the remote operation switches from the first vehicle 10 in the daytime environment to the second vehicle 10 in the nighttime environment. Then, the assistance control unit 235 is capable of performing control to assist with the remote operation of the vehicle 10 based on the determination result of the determination unit 234. In this configuration, there is no need to store the slope information for each vehicle ID in the storage unit 220, enabling a reduction in memory capacity.

### (5) Fifth Modification

In the above-described embodiment, the slope information is used as one example of "relationship information" indicating the relationship between the speed of the vehicle 10 and the motion vector of the surrounding area of the vehicle 10 captured by the camera 120 mounted on the vehicle 10, and control to assist with the remote operation of the vehicle 10 is performed based on the slope information; however, the present disclosure is not limited thereto, and for example, as the relationship information, a motion vector corresponding to the speed of the vehicle 10 may be used. In other words, the assistance control unit 235 may be configured to perform control to assist with the remote operation of the vehicle 10 based on the motion vector corresponding to the speed of the vehicle 10.

For example, similar to the above-described embodiment, before the start of service operation, the vehicle 10 may be caused to travel along a predetermined route, and the slope information calculation unit 141 may calculate, based on an image captured by the camera 120, a magnitude of the motion vector of the surrounding area corresponding to a predetermined speed of the vehicle 10 (e.g., an average value or a cumulative value may be used), and may transmit the calculated magnitude of the motion vector of the surrounding area of the vehicle 10 together with the vehicle ID to the remote operation assistance apparatus 20 for storage. In this case, the speed of the vehicle 10 corresponding to the magnitude of the motion vector of the surrounding area calculated for each vehicle 10 is a common speed (predetermined speed). In other words, in this mode, the configuration is such that all vehicles 10 calculate the magnitude of the motion vector of the surrounding area when traveling at the predetermined speed along a predetermined route before the start of service operation. For example, as illustrated in FIG. 18, the storage unit 220 is capable of storing, for each vehicle ID, the magnitude of the motion vector of the surrounding area (the magnitude of the motion vector corresponding to the predetermined speed) in association with each vehicle ID.

In the present modification, upon receiving an assistance request by the assistance request reception unit 232, the acquisition unit 233 identifies the vehicle ID included in the received assistance request. Then, the acquisition unit 233 acquires, from the storage unit 220, the motion vector associated with the identified vehicle ID. Similar to the above-described embodiment, each time an assistance request is received by the assistance request reception unit 232, the acquisition unit 233 acquires the motion vector.

The determination unit 234 determines whether the motion vector acquired by the acquisition unit 233 decreases. More specifically, in the case where the acquisition unit 233 acquires a first motion vector that indicates a motion vector corresponding to the first vehicle 10 and then acquires a second motion vector that indicates a motion vector corresponding to the second vehicle 10, the determination unit 234 determines whether the second motion vector is smaller than the first motion vector.

Similar to the above-described embodiment, the "second vehicle 10" can be considered to correspond to the vehicle 10 that transmits the most recent assistance request, and the "first vehicle 10" can be considered to correspond to the vehicle 10 that transmitted the recent assistance request immediately before the most recent assistance request, so the "second motion vector" corresponds to the most recently acquired motion vector by the acquisition unit 233, and the "first motion vector" corresponds to the motion vector acquired by the acquisition unit 233 immediately before the second motion vector.

Each time a motion vector is acquired by the acquisition unit 233, the determination unit 234 compares the acquired motion vector with the motion vector acquired by the acquisition unit 233 immediately before the acquired motion vector (immediately previous motion vector), and determines whether the motion vector decreases.

The assistance control unit 235 performs control to assist with the remote operation of the vehicle 10 in the case where the motion vector acquired by the acquisition unit 233 decreases. More specifically, in the case where the determination unit 234 determines that the above-described second motion vector is smaller than the first motion vector, the assistance control unit 235 performs control to assist with the remote operation of the vehicle 10. The details of this control are similar to those in the above-described embodiment. Even with the configuration of the present modification, it is possible to obtain effects similar to those of the above-described embodiments.

### (6) Sixth Modification

In the above-described embodiment, the slope information is previously calculated for each vehicle 10, and at a timing when the vehicle 10 that is the target of remote operation (i.e., the vehicle 10 that transmits the assistance request) is switched, the slope indicated by the slope information (first slope information) corresponding to the vehicle 10 before the switching is compared with the slope indicated by the slope information (second slope information) corresponding to the vehicle 10 after the switching, and, based on the comparison result, whether to execute control to assist with the remote operation of the vehicle 10 is determined. However, the present disclosure is not limited to the above embodiment, and for example, even if the vehicle 10 that is the target of remote operation does not switch and remains the identical vehicle 10, the remote operation assistance apparatus 20 may be configured to calculate slope information while the vehicle 10 is traveling and, when the slope indicated by the calculated slope information decreases, the remote operation assistance apparatus 20 may be configured to perform control to assist with the remote operation of the vehicle 10. For example, in the case where the traveling scene of the vehicle 10 switches from a location with many buildings to a location with fewer buildings, the motion vector of the surrounding area becomes smaller, and the operator's sense of speed is expected to decrease.

Further, for example, when the mode of the camera 120 switches from the wide-angle mode to the telephoto mode, or when the attachment angle θ of the camera 120 changes from a depression angle to an elevation angle, the operator's sense of speed is similarly expected to decrease. In addition, for example, when the environment of the vehicle 10 suddenly changes, such as from clear weather to rainy weather, the operator's sense of speed is similarly expected to decrease. Furthermore, the operator's sense of speed may also vary depending on the conditions of the road on which the vehicle 10 travels. For example, when the number of vehicles traveling alongside vehicle 10 (neighboring vehicles) increases, the range including surrounding vehicles having small motion vectors within the surrounding area of vehicle 10 becomes larger, so that the average value of the magnitudes of the motion vectors of the surrounding area becomes smaller as a result. Thus, the operator's sense of speed also decreases, which creates a possibility that the operator may excessively increase the speed of the vehicle 10.

Even in such cases, the remote operation assistance apparatus 20 is capable of suppressing the operator from excessively increasing the speed of the vehicle 10 by performing the control to assist with the remote operation of the vehicle 10 described above.

The present modification is also applicable to the above-described fifth modification. In other words, even when the vehicle 10 that is the target of remote operation does not switch and remains the identical vehicle 10, the remote operation assistance apparatus 20 is capable of calculating a motion vector corresponding to the predetermined speed while the vehicle 10 is traveling, and performing control to assist with the remote operation of the vehicle 10 when the calculated motion vector decreases.

### (7) Seventh Modification

In the above-described embodiment, the assistance control unit 235 performs control to notify of a decrease in the slope as the control to assist with the remote operation of the vehicle 10, but the present disclosure is not limited thereto, for example, the assistance control unit 235 may be configured to perform control to limit the speed of the vehicle 10 as one example of the control to assist with the remote operation of the vehicle 10.

For example, the assistance control unit 235 is capable of setting a maximum speed so that the vehicle 10 does not exceed the speed limit and controlling the vehicle 10 to travel at a speed less than or equal to the set maximum speed. In addition, for example, the assistance control unit 235 is capable of performing control to apply a reaction force to the accelerator of the vehicle 10 to prevent the vehicle 10 from exceeding the speed limit. Furthermore, for example, the assistance control unit 235 is capable of performing control to guide the operator, via the terminal apparatus 30, so that the operator does not cause the speed of the vehicle 10 to be exceeded. As one example of such control, the assistance control unit 235 is also capable of performing control to cause vection to be displayed on the terminal apparatus 30.

Further, for example, the assistance control unit 235 may be configured to perform control to adjust the viewing angle of the camera 120 to remain constant as one example of control to assist with the remote operation of the vehicle 10 described above. For example, the assistance control unit 235 is capable of performing control to adjust the viewing angle of the camera 120 of the vehicle 10 that is the target of the latest remote operation (second vehicle) so as to be the same as the viewing angle of the camera 120 of the vehicle 10 that is remotely operated by the operator immediately before (first vehicle).

For example, in the case where control to switch the mode of the camera 120 (wide-angle mode → telephoto mode, or telephoto mode → wide-angle mode) is available, when the target of remote operation switches from the vehicle 10 equipped with the wide-angle mode camera 120 (first vehicle 10) to the vehicle 10 equipped with the telephoto mode camera 120 (second vehicle 10), the assistance control unit 235 may be configured to switch the mode of the camera 120 of the second vehicle 10 from the telephoto mode to the wide-angle mode and then initiate (permit) control to assist with the remote operation.

Further, similar to the above, for example, in the case where the attachment angle θ of the camera 120 is adjustable, when the target of remote operation switches from the vehicle 10 having the attachment angle θ of the camera 120 set to a depression angle (first vehicle 10) to the vehicle 10 having the attachment angle θ of the camera 120 set to an elevation angle (second vehicle 10), the assistance control unit 235 may be configured to adjust the attachment angle θ of the camera 120 of the second vehicle 10 from the elevation angle to the depression angle and then initiate (permit) control to assist with the remote operation.

Further, for example, the assistance control unit 235 may be configured to perform control to assist with the remote operation of the vehicle 10 described above for only a predetermined period of time. For example, the assistance control unit 235 may be configured to perform control to assist with the remote operation of the vehicle 10 described above for only a predetermined period of time after the vehicle 10 that is the target of remote operation is switched. This is because assistance is necessary immediately after the vehicle 10 that is the target of remote operation switches, as the operator's sense of speed is most deviated at that time, but as time passes, the operator becomes accustomed to the sense of speed of the new vehicle 10, thus the necessity of assistance also decreases after a predetermined period of time has elapsed.

Moreover, the starting point of the time calculation when the vehicle 10 that is the target of remote operation switches can be set in any manner according to the design conditions or the like, and, for example, the timing at which the assistance request is received by the assistance request reception unit 232 may be set as the starting point, the timing at which the determination by the determination unit 234 is completed may be set as the starting point, or the timing at which the remote operation request is transmitted to the terminal apparatus 30 may be set as the starting point.

### (8) Eighth Modification

In the above-described embodiment, the slope indicated by the slope information is the ratio of change in the motion vector of the surrounding area to change in the speed of the vehicle 10; however, the present disclosure is not limited thereto, and for example, the slope indicated by the slope information may be the ratio of change in the speed of the vehicle 10 to change in the motion vector of the surrounding area. In other words, a configuration may be adopted in which the slope information is calculated by setting a coordinate system in which the horizontal axis of FIG. 5 represents the motion vector of the surrounding area of the vehicle 10 and the vertical axis represents the speed of the vehicle 10. In this case, contrary to the above-described embodiment, the assistance control unit 235 performs control to assist with the remote operation of the vehicle 10 when the slope indicated by the slope information acquired by the acquisition unit 233 increases.

In the present modification, contrary to the above-described embodiment, when the average value of the magnitudes of the motion vectors of the surrounding area decreases, the slope indicated by the above-described slope information increases, and thus in this case, the operator's sense of speed is expected to decrease. Examples of cases in which the average value of the magnitudes of the motion vectors of the surrounding area decreases are similar to those described above, and for example, such a situation is expected to occur when the vehicle 10 that is the target of remote operation (the vehicle 10 that transmits the assistance request) switches from the vehicle 10 equipped with the wide-angle mode camera 120 to the vehicle 10 equipped with the telephoto mode camera 120. As described above, other cases are also expected, such as when the vehicle 10 that is the target of remote operation switches from the vehicle 10 in which the attachment angle θ of the camera 120 is a depression angle to the vehicle 10 in which the attachment angle θ of the camera 120 is an elevation angle, when the switch occurs from the vehicle 10 in a clear weather or daytime environment to the vehicle 10 in a rainy weather or nighttime environment, or when the switch occurs from the vehicle 10 in an area with many surrounding structures to the vehicle 10 in an area with few surrounding structures.

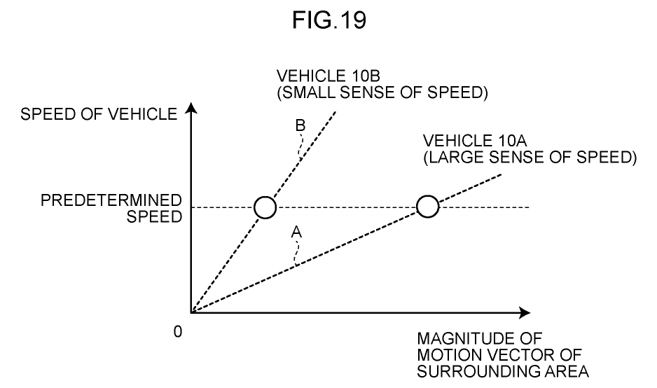

In the remote operation assistance apparatus 20 according to the present modification, the determination unit 234 determines whether the slope indicated by the slope information acquired by the acquisition unit 233 increases. In the case where the acquisition unit 233 acquires first slope information corresponding to the first vehicle 10 and subsequently acquires second slope information corresponding to the second vehicle 10, the determination unit 234 determines whether the slope indicated by the second slope information is greater than the slope indicated by the first slope information. Then, in the case where the determination unit 234 determines that the slope indicated by the second slope information is greater than the slope indicated by the first slope information, the assistance control unit 235 performs control to assist with the remote operation of the vehicle 10. For example, if the slope indicated by the slope information acquired by the acquisition unit 233 increases from the slope of line A corresponding to the vehicle 10A illustrated in FIG. 19 to the slope of line B corresponding to the vehicle 10B, the assistance control unit 235 can perform, as the control to assist with the remote operation of the vehicle 10 described above, control to suppress the operator from excessively increasing the speed of the vehicle 10. In short, the assistance control unit 235 may be configured to perform control to assist with the remote operation of the vehicle 10 in response to a change in the slope indicated by the slope information acquired by the acquisition unit 233.

### (9) Ninth Modification

The camera 120 described above is arranged so as to capture an image of the front of the vehicle 10, and the slope information is calculated using the image of the front of the vehicle 10, but the present disclosure is not limited thereto; for example, the slope information may be calculated using an image of the rear of the vehicle 10 or an image of either one of the left or right side of the vehicle 10.

### (10) Tenth Modification

In the remote operation system 1 according to the above-described embodiment, the vehicle 10 used therein may be, for example, a four-wheeled vehicle or a two-wheeled vehicle. In addition, the vehicle 10 may also be, for example, an automatic guided vehicle (AGV), construction machinery, agricultural machinery, drones, or the like.

### (11) Eleventh Modification

In the above-described embodiment, each vehicle 10 calculates slope information; however, the present disclosure is not limited thereto, and, for example, the remote operation assistance apparatus 20 may be configured to calculate slope information. In this configuration, the remote operation assistance apparatus 20 is capable of receiving speed information and an image from each vehicle 10 to calculate the slope information for each vehicle 10 based on the received speed information and image.

### (12) Twelfth Modification

For example, even in the case of satisfying a condition for performing control to assist with the remote operation of the vehicle 10 (hereinafter referred to as "assistance condition"), the assistance control unit 235 may be configured not to perform control to assist with the remote operation.

For example, even when the assistance condition described above is satisfied, the assistance control unit 235 may be configured not to perform control to assist with the remote operation, if an assistance request is received from the second vehicle 10 after a predetermined period of time has elapsed since the remote operation of the first vehicle 10 was stopped. It is assumed that the sense of speed for the first vehicle 10 disappears or diminishes after a predetermined period of time has elapsed since the remote operation of the first vehicle 10 was stopped, so control for assisting the remote operation is unnecessary in such a case.

Further, for example, the assistance control unit 235 may be configured not to perform control to assist with the remote operation, even when the above-described assistance condition is satisfied, if the time during which the first vehicle 10 is remotely operated (remote control time) is less than a predetermined time. Since, when the time during which the first vehicle 10 is remotely operated is short, the sense of speed for the first vehicle 10 is considered to hardly remain, control to assist with the remote operation is unnecessary in such a case.

Further, for example, the assistance control unit 235 may be configured not to perform control to assist with the remote operation, even when the above-described assistance condition is satisfied, if the maximum speed of the first vehicle 10 during the remote operation is less than a predetermined value. Since, when the maximum speed of the first vehicle 10 during the remote operation is low (e.g., traveling at a slow speed), the sense of speed for the first vehicle 10 hardly remains and the influence caused by the difference from the sense of speed of the second vehicle 10 is not considered significant, control to assist with the remote operation is unnecessary in such a case.

Further, for example, the assistance control unit 235 may be configured not to perform control to assist with the remote operation even when the above-described assistance condition is satisfied, and, when the first vehicle 10 during the remote operation reaches a predetermined speed, to perform an output notifying such a situation (e.g., an output that displays an image on the terminal apparatus 30 or an output that emits sound from the terminal apparatus 30).

The above-described "predetermined speed" may be, for example, the maximum speed. The notification of the maximum speed of the first vehicle 10 during remote operation enables the operator to recognize the maximum speed of the first vehicle 10 when remotely controlling the second vehicle 10, thereby allowing the operator to remotely control the second vehicle 10 safely while remaining aware of the sense of speed. Moreover, the above-described "predetermined speed" is not limited to the maximum speed, and may be, for example, the straight-line speed (the speed at which the acceleration becomes constant) during the remote operation of the first vehicle 10, or the speed at which the traveling time is the longest. In short, the "predetermined speed" may be any speed capable of reminding the operator of the sense of speed of the first vehicle 10 during remote operation (i.e., a speed that affects the sense of speed).

Further, for example, the assistance control unit 235 may be configured not to perform control to assist with the remote operation even if the above-described assistance condition is satisfied, and when the accelerator depression amount reaches or exceeds a predetermined value during remote operation of the second vehicle 10, to perform an output notifying such a situation. This makes it possible to prevent speeding in advance.

In this context, since the "second vehicle 10" can be regarded as corresponding to the vehicle 10 that has transmitted the most recent assistance request and the "first vehicle 10" can be regarded as corresponding to the vehicle 10 that transmitted an assistance request immediately prior to the most recent assistance request, the "second slope information" corresponds to the slope information most recently acquired by the acquisition unit 233, and the "first slope information" corresponds to the slope information acquired by the acquisition unit 233 immediately before the second slope information. In the present embodiment, each time slope information is acquired by the acquisition unit 233, the determination unit 234 compares the slope indicated by the most recently acquired slope information (second slope information) with the slope indicated by the slope information acquired immediately before the most recently acquired slope information (first slope information), and determines whether the slope indicated by the slope information decreases.

The assistance control unit 235 performs control to assist with the remote operation of the vehicle 10 based on the slope information acquired by the acquisition unit 233. More specifically, the assistance control unit 235 performs control to assist with the remote operation of the vehicle 10 in response to a change in the slope indicated by the slope information acquired by the acquisition unit 233. In the present embodiment, the assistance control unit 235 performs control to assist with the remote operation of the vehicle 10 when the slope indicated by the slope information acquired by the acquisition unit 233 decreases. Furthermore, the assistance control unit 235 performs control to assist with the remote operation of the vehicle 10 when the determination unit 234 determines that the slope indicated by the second slope information described above is smaller than the slope indicated by the first slope information described above.

The embodiments described herein can be combined in any manner with the above-described modifications, and the above-described modifications may also be combined in any manner.

According to an embodiment, it is possible to appropriately assist with remote operation by an operator. Note that the effects described herein are not necessarily limiting, and any other effects described elsewhere herein may also be achieved.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A remote operation assistance method executed by a remote operation assistance apparatus configured to assist with remote operation of a vehicle, the method comprising:
acquiring relationship information indicating a relationship between a speed of the vehicle and a motion vector of a surrounding area of the vehicle captured by a camera mounted on the vehicle; and
performing control to assist with the remote operation of the vehicle based on the relationship information acquired at the acquiring.

2. The remote operation assistance method according to claim 1, wherein
the relationship information comprises slope information indicating a slope that is a ratio of a change in the motion vector to a change in a speed of the vehicle, and
the performing comprises performing control to assist with the remote operation of the vehicle in response to a change in the slope indicated by the slope information.

3. The remote operation assistance method according to claim 2, wherein
the slope is a ratio of the change in the motion vector to the change in the speed of the vehicle, and
the performing comprises performing control to assist with the remote operation of the vehicle in a case where the slope indicated by the slope information decreases.

4. The remote operation assistance method according to claim 3, further comprising:
in a case where first slope information indicating the slope corresponding to a first vehicle is acquired and subsequently second slope information indicating the slope corresponding to a second vehicle is acquired at the acquiring, determining whether the slope indicated by the second slope information is smaller than the slope indicated by the first slope information, wherein
the performing comprises performing control to assist with the remote operation of the vehicle in a case where it is determined at the determining that the slope indicated by the second slope information is smaller than the slope indicated by the first slope information.

5. The remote operation assistance method according to claim 4, wherein
the slope information is associated with each combination of the vehicle and a viewing angle of the camera, and
in a case where the first slope information corresponding to a combination of the first vehicle and the viewing angle is acquired and subsequently the second slope information corresponding to a combination of the second vehicle and the viewing angle is acquired at the acquiring, the determining comprises determining whether the slope indicated by the second slope information is smaller than the slope indicated by the first slope information.

6. The remote operation assistance method according to claim 4, wherein
the slope information is associated with each combination of the vehicle and a location, and
in a case where the first slope information corresponding to a combination of the first vehicle and the location is acquired and subsequently the second slope information corresponding to a combination of the second vehicle and the location is acquired at the acquiring, the determining comprises determining whether the slope indicated by the second slope information is smaller than the slope indicated by the first slope information.

7. The remote operation assistance method according to claim 1, wherein
the relationship information is information indicating the motion vector corresponding to the speed of the vehicle, and
the performing comprises performing control to assist with the remote operation of the vehicle in a case where the motion vector corresponding to the speed of the vehicle decreases.

8. The remote operation assistance method according to claim 7, further comprising:
in a case where a first motion vector indicating a motion vector corresponding to a first vehicle is acquired and subsequently a second motion vector indicating a motion vector corresponding to a second vehicle is acquired at the acquiring, determining whether the second motion vector is smaller than the first motion vector, wherein
the performing comprises performing control to assist with the remote operation of the vehicle in a case where it is determined at the determining that the second motion vector is smaller than the first motion vector.

9. The remote operation assistance method according to claim 3, wherein
the control to assist with the remote operation of the vehicle comprises control to notify of decrease in the slope or the motion vector.

10. The remote operation assistance method according to claim 3, wherein
the control to assist with the remote operation of the vehicle comprises control to limit the speed of the vehicle.

11. The remote operation assistance method according to claim 3, wherein
the control to assist with the remote operation of the vehicle comprises control to adjust a viewing angle of the camera to remain constant.

12. The remote operation assistance method according to claim 3, wherein
the control to assist with the remote operation of the vehicle is performed only for a predetermined period of time.

13. A remote operation assistance apparatus comprising:
a memory; and
a hardware processor coupled to the memory and configured to:
acquire relationship information indicating a relationship between a speed of a vehicle that is a target of remote operation and a motion vector of a surrounding area of the vehicle captured by a camera mounted on the vehicle; and
perform control to assist with the remote operation of the vehicle based on the acquired relationship information.

14. A computer program product including programmed instructions embodied in and stored on a non-transitory computer readable medium, wherein the instructions, when executed by a computer, cause the computer to perform:
acquiring relationship information indicating a relationship between a speed of the vehicle and a motion vector of a surrounding area of the vehicle captured by a camera mounted on the vehicle; and
performing control to assist with the remote operation of the vehicle based on the relationship information acquired at the acquiring.
